(19) United States
(12) Patent Application Publication
(10) Pub. No.: US 2002/0071731 A1
(43) Pub. Date: Jun. 13, 2002

(54) METHOD OF MACHINING SPHERICAL SURFACES OF PISTON FOR SWASH PLATE TYPE COMPRESSOR

(75) Inventor: YOSHITAKA OOTSUKI, GUNMA (JP)

Correspondence Address: BAKER & BOTTS LLP, THE WARNER, 1299 PENNSYLVANIA AVE N W, WASHINGTON, DC, 200042400

(73) Assignee: ootsuki

(21) Appl. No.: 09/459,347

(22) Filed: Dec. 13, 1999

(30) Foreign Application Priority Data
Dec. 14, 1998 (JP) 355010/1998

(51) Int. Cl. B23C 3/00

(52) U.S. Cl. 409/132

(57) ABSTRACT

In a method of machining the spherical surfaces of a piston for a swash plate type compressor for machining the spherical surfaces of the swash-plate-passing-slot of the piston through which a swash plate passes, wherein the swash plate rotates about a rotating axis and the peripheral edge surfaces of the swash plate carry out a reciprocating motion in a direction substantially along the rotating axis and the motion of the swash plate is converted into a reciprocating motion in a cylinder bore by the piston through spherical shoes. The method comprises the step of machining the spherical recesses of both the end surfaces of the swash-plate-passing-slot for accommodating and retaining the spherical portions of the spherical shoes by moving the center axis of a tool element having a spherical cutter from the rotational center axis of a machine tool while rotating the tool element.

### BACKGROUND OF THE INVENTION

1. Field of the Invention

The present invention relates to a method of machining the shoe-receiving recesses of a piston for a swash plate type compressor.

2. Description of the Related Art

Conventionally, swash plate type compressors include a both swash plate type compressor having double-headed pistons and a single swash plate type compressor having a head at an end thereof. The conventional swash plate type compressors include a swash plate on a rotating shaft supported by a cylinder block and a front housing, pistons accommodated in the cylinder block so as to reciprocate therein, and spherical shoes interposed between the swash plate and each piston.

In the conventional swash plate type compressor arranged, shoe-receiving recesses are machined on both the end surfaces of a swash-plate-passing-slot formed on the skirt of each piston with a spherical cutter by rotating a workpiece (refer to Japanese Unexamined Patent Publication No. 10-220354 which is hereinafter referred to as conventional art 1).

However, in the piston spherical surface machining method disclosed in the conventional art 1, since the spherical surfaces of the piston are machined by rotating the piston itself and fixing a tool element, it is difficult to spherically machine a wide accommodating slot of the piston and confronting surfaces of the slot having a very narrow width. This is because they must be machined by moving the rotational axis of the piston with respect to the tool.

Further, in the piston spherical surface machining method disclosed in the conventional art 1, since machining is carried out by rotating the piston itself and fixing the tool element, the method has a drawback that the accuracy of spherical surfaces is lowered when a single piston has two slots, that is, when the two slots are machined at two positions. This is because a rotating section is badly balanced.

Therefore, in the piston spherical surface machining method disclosed in the conventional art 1, when the depths of the shoe-receiving recesses on both the end surfaces of the swash-plate-passing-slot are maintained constant and the width of the swash-plate-passing-slot is changed, a disadvantage arises in that the perfect sphere of the shoe-receiving recesses is changed to, for example, oval.

### SUMMARY OF THE INVENTION

It is an object of the present invention to provide a method of machining the spherical surfaces of a piston for a swash plate type compressor capable of simply changing the width of a swash-plate-passing-slot while maintaining the depths of shoe-receiving recesses constant by machining the recesses.

It is another object of the present invention to provide a method of machining the spherical surfaces of the piston for the swash plate type compressor capable of carrying out machining without replacing a tool even if the width of the swash-plate-passing-slot of the piston is changed.

It is still another object of the present invention to provide a method of machining the spherical surfaces of the piston for the swash plate type compressor capable of carrying out machining at a high speed without moving a workpiece, for example, the piston.

It is yet another object of the present invention to provide a method of machining the spherical surfaces of the piston for the swash plate type compressor capable of easily carrying out positional alignment by moving only a tool element.

According to the present invention, there is provided a method of machining the spherical surfaces of a piston for a swash plate type compressor for machining the spherical surfaces of the swash-plate-passing-slot of the piston through which a swash plate passes. In the swash plate type compressor, the swash plate rotates about a rotating axis and the peripheral edge surfaces of the swash plate carry out a reciprocating motion in a direction substantially along the rotating axis and the motion of the swash plate is converted into a reciprocating motion in a cylinder bore by the piston through spherical shoes. The method includes the step of machining the spherical recesses of both the end surfaces of the swash-plate-passing-slot for accommodating and retaining the spherical portions of the spherical shoes by moving the center axis of a tool element having a spherical cutter from the rotational center axis of a machine tool while rotating the tool element.

In the present invention, the width of the swash-plate-passing-slot is preferably larger than the radius of rotation of the cutter of the tool rotating about the rotational center axis of the machine tool.

Further, in the present invention, the piston preferably has a plurality of the swash-plate-passing-slots disposed in a connected row arrangement in the width direction thereof.

Specifically, the present invention provies a method of moving the rotational center axis of the machine tool from the center axis of the swash-plate-passing-slot and moving the center axis of the tool element from the rotational center axis of the machine tool. In that case, a workpiece is fixed and only the tool element is moved.

Note that when a portion to be machined has a wide slot, the machine tool is also moved so as to machine each side of the slot.

### BRIEF DESCRIPTION OF THE DRAWINGS

FIG. 1 is a view showing a method of machining a workpiece with a tool having a spherical cutter by rotating the workpiece according to conventional art;

FIG. 2 is an enlarged view of FIG. 1 showing shoe-receiving recesses;

FIG. 3 is a view for use in explaining an example of drawbacks of the conventional art;

FIG. 4 is a view for use in explaining another example of the drawbacks of the conventional art;

FIG. 5 is a longitudinal sectional view of a swash plate type compressor according to an embodiment of the present invention;

FIG. 6 is a view showing a method of machining the spherical surfaces of a piston for a compressor shown in FIG. 5; and

FIG. 7 is an enlarged view of shoe-receiving recesses of FIG. 6.

### DESCRIPTION OF THE PREFERRED EMBODIMENT

Prior to the description of a preferable embodiment of the present invention, a piston spherical surface machining method according to conventional art will be described with reference to FIGS. 1 to 4 for easy understanding of the present invention.

Referring to FIG. 1, first, a tool element 23 having a spherical cutter 21 is set between a pair of walls 17 and 19 facing inwardly of a slot 15 of a skirt 13 of a piston 11 in such a manner that an axial line 25 of the tool element 23 is substantially perpendicular to an extended line 27 of the piston 11 extended from a center axis thereof. The piston 11 is rotated about a rotating axis 33 thereof passing through the center of shoe-receiving recesses 29 and 31 at the midpoint between the walls 17 and 19. Then, the spherical shoe-receiving recesses 29 and 31 are machined on the pair of walls 17 and 19 by moving the tool element 23 from the position where it is set to a position where the center Cl of the spherical cutter 21 of the tool element 23 coincides with the rotating axis 33 of the piston 11.

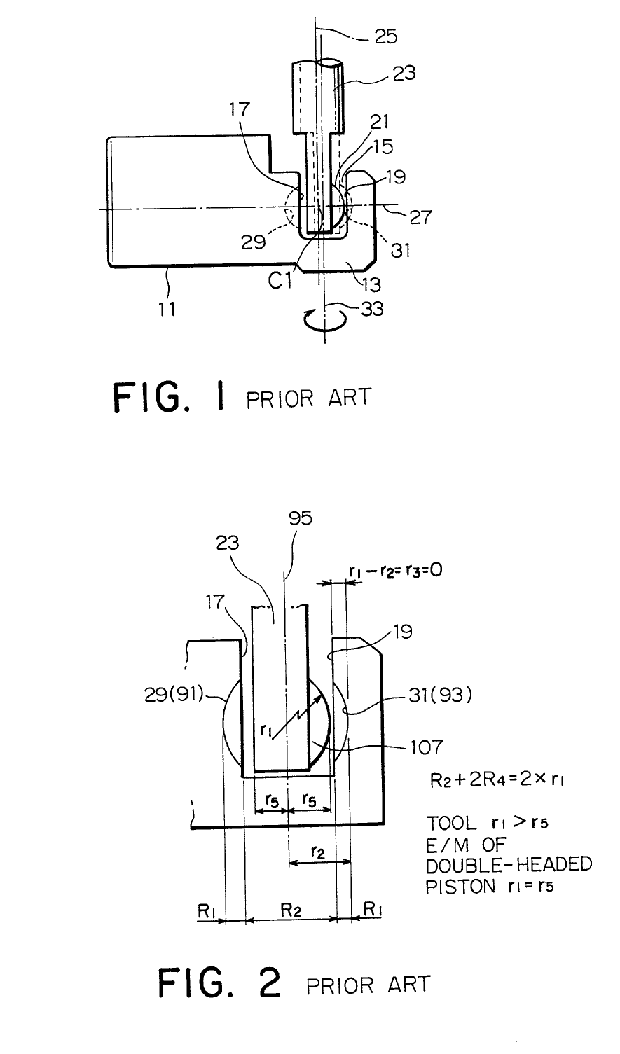

Referring to FIG. 2, a distance R2+2R1 of the deepest portion of the recesses 29 and 31 is the same as the diameter 2r1 of the cutter 21 of the tool element 23. Further, a half thickness of the tool element 23 r5 is smaller than a radius r1 of the cutter.

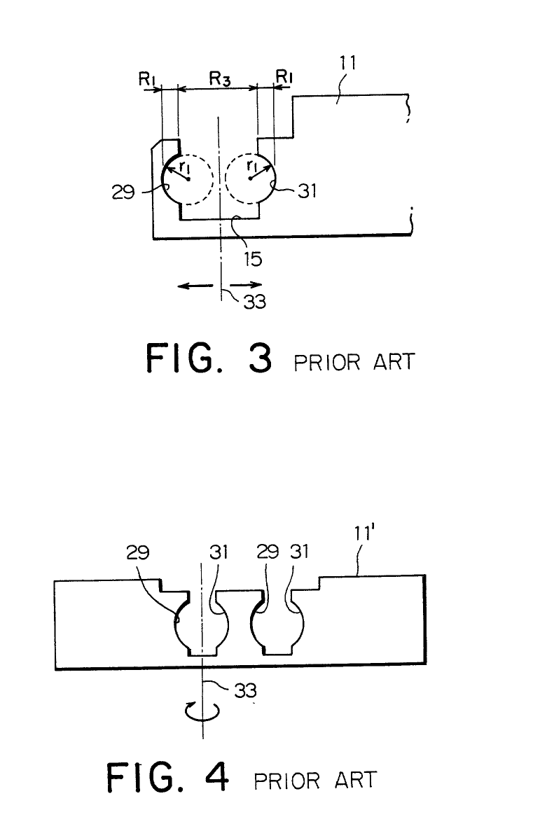

The conventional art 1 has the following drawbacks as shown in FIGS. 3 and 4.

Referring to FIG. 3, a size of a slot width R3 is larger than the value obtained by subtracting twice the depth of the shoe-receiving recess 31 2R1 from twice the radius of the distal end of the spherical cutter 21 2r1.

When the machining shown in FIG. 3 is carried out using the machining method shown in FIG. 1, a rotating axis 33 of a workpiece, for example, the piston 11 is located on the center axis of the slot 15 of the piston 11. As a result, the walls 17 and 19 cannot be spherically machined, that is, a rotating axis 95 must be moved right and left as shown by arrows to spherically machine the walls 17 and 19.

As shown in FIG. 4, according to the conventional art 1, when two sets of recesses are machined, spherical portions cannot be accurately machined because a rotating section is badly balanced.

Accordingly, in the piston spherical surface machining method disclosed in the conventional art 1, when the width of the swash-plate-passing-slot 15 is changed while maintaining the depths of the shoe-receiving recesses on both the end surfaces of the swash-plate-passing-slot 15 constant, the perfect sphere of the shoe-receiving recesses is changed to, for example, an oval shape and it is difficult to form perfectly spherical surfaces.

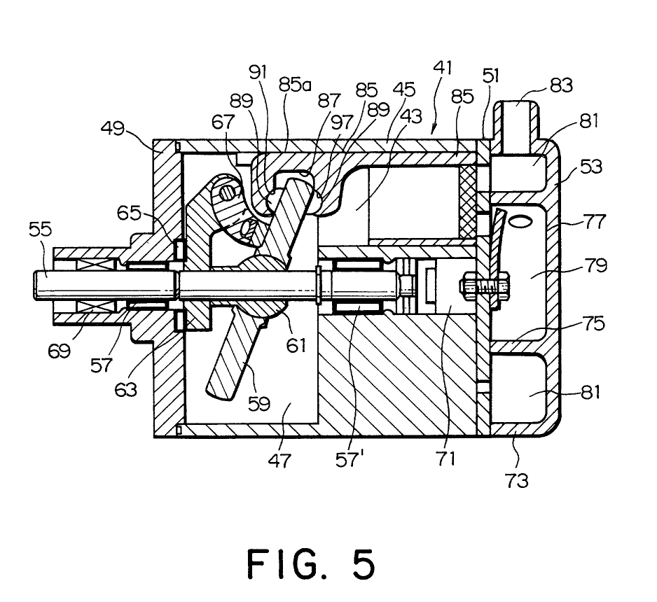

Next, an embodiment of the present invention will be described with reference to FIGS. 5 to 7.

FIG. 5 shows a swash plate type compressor having a piston to which the present invention is applied. The swash plate type compressor 41 is also called a single swash plate type compressor. The swash plate type compressor 41 includes a plurality of cylinder bores 43 which are composed of holes passing from one side to the other side of the compressor.

Further, the swash plate type compressor 41 includes a cylinder block 45, a front housing 49 and a cylinder head 53. The cylinder block 45 has an open end and is arranged integrally with a housing. The front housing 49 covers the opening of the cylinder block 45 and defines a crank chamber 47 therein together with an end surface of the cylinder block 45. The cylinder bores 43 is disposed to the other end of the cylinder block 45 through a valve plate unit 51.

A rotating shaft 55 is disposed so as to pass through the crank chamber 47 from the front housing 49 to the cylinder block 45.

The rotating shaft 55 is supported by the front housing 49 through a bearing 57 at a portion near to an end thereof. A swash plate 59 is supported by a spherical support member 61 and disposed in the vicinity of the rotating shaft 55 in the crank chamber 47. A rotor 63 is disposed adjacent to the swash plate 59 with an end thereof supported by the front housing 49 through a bearing 65. The other end of the rotor 63 is connected to an end of the swash plate 59 through a connecting member 67. A seal member 69 is disposed to a distal end of the rotating shaft 55 and a pressure control unit 71 is disposed to the other distal end thereof.

A discharge chamber 79 is defined by an outer wall 73, an inner wall 75 and a bottom wall 77 of the cylinder head 53 and also an end surface of the valve plate unit 51. In addition, a suction port 83 connecting to a suction chamber 81 is disposed.

Further, a piston 85 is accommodated in each cylinder bore 43 so as to slide and move along the lengthwise direction thereof. The outer periphery of the swash plate 59 is accommodated in a swash-plate-passing-slot 87 disposed to a skirt 85a. Recesses 91 and 93 for receiving shoes 89 and 89 are formed on the confronting surfaces, that is, the side walls of the swash-plate-passing-slot 87. One surface of each shoe 89 is a flat and the other surface thereof is formed to a hemispherical shape. One surface of each shoe 89 is abutted against a peripheral edge surface of the swash plate 59. Further, hemispherical surfaces of the shoes 89 and 89 are received by the recesses 91 and 93. The shoe-receiving recesses 91 and 93 must have proper depths R1 to retain the shoes 89 and 89. Further, the shoe-receiving recesses 91 and 93 must be formed to perfect sphere so that they are not worn in sliding contact with the shoes 89 and 89.

In the swash plate type compressor 41 which is arranged as described above and used in the present invention, when the rotating shaft 55 is rotated, the rotor 63 is rotated together with the rotating shaft 55. The swash plate 59, which is connected to the rotor 63 through the connecting member 67, is also rotated by the rotation of the rotor 63 similarly. The swash plate 59 is tilted with respect to the rotating shaft 55 by a predetermined angle. As a result, the peripheral surface of the swash plate 59 makes a reciprocating motion in a direction substantially along the rotating shaft 55 in such a manner that both the peripheral edges of the swash plate 59 on a linear line are substantially symmetrical about a point of the rotating shaft 55 in the lengthwise direction thereof at opposite positions across the rotating shaft 55.

The reciprocating motion of the swash plate 59 is converted into the reciprocating motion of the piston 83 through the respective shoes 89 and 89 attached to the swash plate 59 with the one surfaces thereof abutted against the outer confronting surfaces of the swash plate 59 and the spherical surfaces thereof in contact with the spherical surfaces of the recesses 91 and 93 of the slot 87.

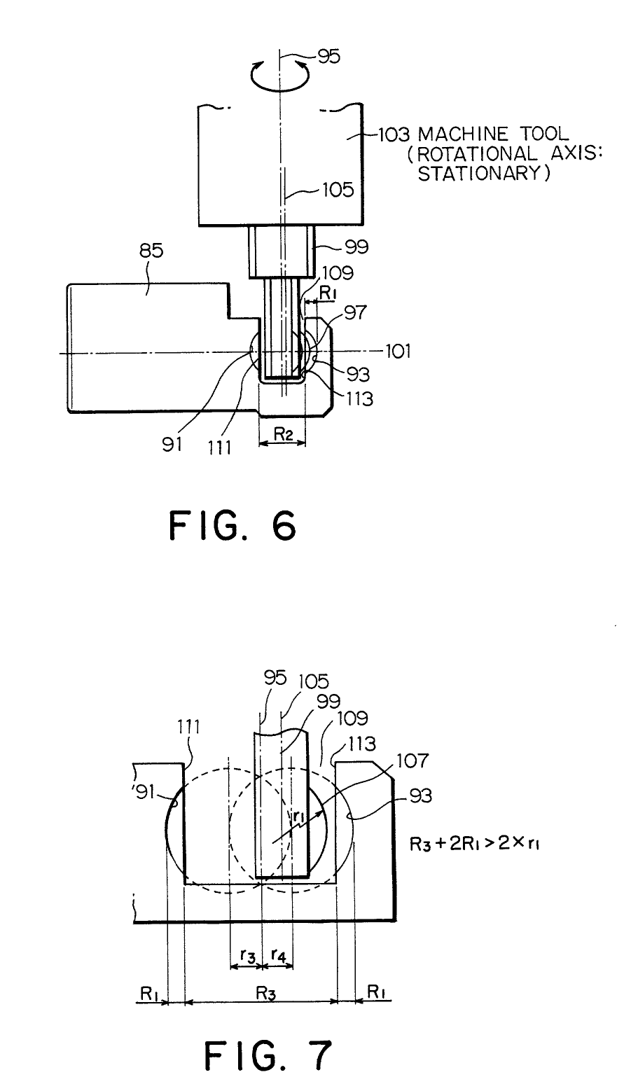

Next, a method of machining the spherical surfaces of a piston according to the embodiment of the present invention with reference to FIGS. 6 and 7.

As shown in FIG. 6, a tool element 99 having a spherical cutter 107 is set on a center axis 97 of the swash-plate-passing-slot 87 of the piston 85 such that the axial line 105 of the tool element 99 is substantially perpendicular to an extended axial line 101 of the piston 83.

As shown in FIG. 7, when R3+2R1>2×r1, the shoe receiving recesses 91 and 93 are machined by rotating a machine tool 103 about a rotational center axis 95 such that a center axis 105 of the tool element 99, that is, the spherical cutter 107 shown in FIG. 7 is moved from the rotational center axis 95 until r1 is made equal to r2 and the rotational center axis 95 of the machine tool 103 is moved by r3 in the direction of a surface 111, which confronts the tool element 99, of a swash-plate-passing-slot 109 and by r4 in the direction of a surface 113 thereof.

Note that when the slot width R2 and twice the depth of the recess 91 2R1 is equal to twice the radius r1 of the nose of the cutter 107 of the tool element 99, that is, when R2+2R1=2×r1 as shown in the conventional art, the shoe receiving recesses 91 and 93 can be also machined by rotating the machine tool 103 about the rotational center axis 95 such that the center axis of 105 of the tool element 99, that is, the spherical cutter 107 is moved from the rotational center axis 95 until r1 is made equal to r2 as shown in FIG. 2.

As described above, according to the piston spherical surface machining method of the present invention, the method of machining the spherical surfaces of a piston for a swash plate type compressor can be provided. In the method, the side surfaces of a swash-plate-passing-slot can be simply machined spherically while maintaining the depths of shoe receiving recesses constant by machining the recesses.

According to the present invention, the method of machining the spherical surfaces of the piston for the swash plate type compressor can be provided which can carry out machining without replacing a tool even if the slot width of the slot of the swash-plate-passing-slot of the piston is changed and without changing the depths and perfect sphere of the shoe receiving recesses formed on both the ends of the slot even if the width of the swash-plate-passing-slot is changed.

According to the present invention, the method of machining the spherical surfaces of the piston for the swash plate type compressor can be provided which can carry out machining at a high speed without moving a workpiece.

Further, according to the present invention, the method of machining the spherical surfaces of the piston for the swash plate type compressor can be provided which can easily carry out positional alignment by moving only a tool.

What is claimed is:

1. A method of machining the spherical surfaces of a piston for a swash plate type compressor for machining the spherical surfaces of the swash-plate-passing-slot of the piston through which a swash plate passes, the swash plate rotating about a rotating axis, peripheral edge surfaces of the swash plate carrying out a reciprocating motion in a direction substantially along the rotating axis, the motion of the swash plate being converted into a reciprocating motion in a cylinder bore by the piston through spherical shoes, said method comprising the step of machining the spherical recesses of both the end surfaces of the swash-plate-passing-slot for accommodating and retaining the spherical portions of the spherical shoes by moving a center axis of a tool element having a spherical cutter from a rotational center axis of a machine tool while rotating the tool element.

2. A method according to claim 1, wherein the width of the swash-plate-passing-slot is larger than the radius of rotation of the cutter of the tool element rotating about the rotational center axis of the machine tool.

3. A method according to claim 1, wherein the piston has a plurality of the swash-plate-passing-slots disposed in a connected row arrangement in the width direction thereof.
